(19) United States
(12) Patent Application Publication
(10) Pub. No.: US 2011/0043014 A1
(43) Pub. Date: Feb. 24, 2011

(54) CAR SEAT FOR A CHILD

(76) Inventors: Gregory John Templaman, MINYIP (AU); Anne-Marie Templeman, Minyip (AU)

Correspondence Address: Douglas Gergich;Intellectual Property Docketing Department, 925 Fourth Avenue, Suite 2900, Seattle, WA, 98104-1158, US

(21) Appl. No.: 12/811,630

(22) PCT Filed: Sep. 4, 2008
(86) PCT No.: PCT/AU08/01316

§ 371 Date: Sep. 13, 2010

(30) Foreign Application Priority Data
Jan. 7, 2008 (AU) 2008900075

(51) Int. Cl. B60N 2/28

(52) U.S. Cl. 297/255

(57) ABSTRACT

The invention concerns a child seat for a car with a rear passenger seat that divides a passenger cabin space and a rear storage space and that is foldable to provide access to the rear storage space from the passenger cabin space. The child seat comprises a seat for a child and a mounting that links the seat to the car. The mounting is operable to transfer the seat between the rear storage space and the passenger space for storage and for carrying a child, respectively.

### FIELD OF THE INVENTION

This invention relates to a car seat for a child.

### BACKGROUND OF THE INVENTION

Passenger safety in a car is important, and is particularly important for children.

Safety restraints for adults and tall children comprise lap-sash seatbelts that extend over the hips to a buckle, diagonally across the torso and over a shoulder. In an accident, the lap portion prevents “submarining”, i.e. sliding of the body below the restraint, and the torso portion restrains the upper body.

Young children, such as toddlers and infants, however, are at risk of injury in collisions because the lap-sash restraint does not restrain the child in the same way is does an adult.

Specifically, the torso portion may pass over the throat or head of the child or may not contact the child at all. The lap portion restrain may sit across the belly of the child rather than over the hips, and thereby cause abdominal injuries or submarining in a collision.

For such children, restraints that pass over each shoulder, the hips and between the legs to a central buckle are preferred. However, such restraints are not a standard feature of vehicles.

To cater for young children, a child seat is required. Such seats typically comprise a plastics moulded seat that is appropriately sized for comfortably seating a child and a child restraint such as that mentioned above. However, the child seat is installed in a car with either the lap-sash restraint or with interlocking elements that are on the child seat and on a frame fitted to the car post-production.

While either installation option is safe, the child seats create problems in terms of convenience because they are often tricky to install quickly and are difficult to store without losing significant amount of storage space from a boot (also known as a “trunk”) of the car.

For example, taxis generally do not carry child seats in the boot because to do so would involve sacrificing boot space. Most fares do not require use of boot space, but it is an important factor that determines whether airport fares can be picked up. As a result, taxis return to base to pick up and install a child seat. But this consumes time and may result in missing other fares. Alternatively, taxis simply refuse to accept fares that require a child seat. In which case the taxi is disadvantaged through the loss of a potential fare and the prospective fare disadvantaged due to limited availability of taxis.

In the circumstances of a family car, the same luggage capacity sacrificing problems apply. However, in most cases the child seat will be installed in the car for long periods of time. This is due to a perception that the child seat is more conveniently left installed in the car because the effort to remove the child seat, store it and then reinstall the child seat when required next is too great.

As a result, there is limited flexibility in use of the car because the rear seat cannot be occupied by adults when the child seat is installed. Unless there is a particularly great need, alternative travel arrangements generally will be made and the child seat will remain installed in the car.

### SUMMARY OF THE INVENTION

The invention is concerned with providing a child seat for a car that improves flexibility for use of a rear passenger seat by children in a child seat and by adults.

The invention provides a child seat for a car with a rear passenger seat that divides a passenger cabin space and a rear storage space and that is foldable to provide access to the rear storage space from the passenger cabin space, the child seat comprising a seat for a child and a mounting that links the seat to the car, the mounting is operable to transfer the seat between the rear storage space and the passenger cabin space for stowing the seat in the rear storage space and for locating the seat in the passenger cabin space to carry a child when the rear passenger seat is folded, respectively.

An important aspect of the invention is the ability to store the child seat in the rear storage space when not in use and to retrieve the child seat via the passenger cabin space when it is needed for use. This provides a high degree of convenience because conventional child seats typically require removal from the car altogether when not in use. Similarly, in the event the child seat needs to be used, the child seat remains in the car and can be retrieved when required. For taxis, this is important because fares that request a child seat are either ignored or require a taxi to return to base to pick up and install a child seat. This takes time and is inefficient. Moreover, taxis prefer not to carry a child seat in the rear storage space because it compromises luggage capacity, particularly for fares to and from airports.

The term “rear storage space” is understood to mean a trunk or a boot of a car.

Preferably, the child seat is a permanent fixture in the car. Alternatively, the child seat is retro-fittable to become a permanent fixture in the car.

Preferably, the car includes a parcel shelf which, in conjunction with the rear passenger seat, divides the passenger cabin space and the rear storage space and the mounting is configured to locate the seat such that at least part of the seat is in abutment with or close to abutting the parcel shelf when the seat is located in the passenger cabin space for carrying a child.

Boot space that is least commonly used is the area immediately behind the rear passenger seats and above the floor of the boot, i.e. underneath the parcel shelf. Accordingly, configuring the mounting to stow the seat in that space avoids substantial loss of boot storage capacity because the stowed seat does not project into the commonly used boot storage space.

Accordingly, the mounting operates such that the seat is retrieved through an opening formed by folding the rear passenger seat and transferring the seat from the rear storage space through an opening and below the level of the parcel shelf and then arranging the seat in an orientation for carrying out child when the seat is located in the passenger cabin space. It is important rear-end collisions to support the seat at the base and close to the top of the seat by abutment with the parcel shelf or by location close to abutment with the parcel shelf.

Preferably, the mounting is configured to retain the seat in close proximity to the parcel shelf.

Preferably, the mounting is configured to retain the seat above the floor of the rear storage space.

Preferably, the mounting is affixed to framework of the car associated with the parcel shelf.

Preferably, the mounting is affixed to the rear of the foldable rear passenger seat such that the seat is stored in the rear storage space when the rear passenger seat is located in an upright position to divide the rear storage space from the passenger cabin space.

Preferably, the mounting includes a support that directs the seat upwardly to a position in close proximity to the parcel shelf.

Preferably, the seat is pivotably linked to the mounting for orienting the seat between a reclined position for transferring the seat between the passenger cabin space and the rear storage space and an upright position for seating a child.

Preferably, the mounting includes at least one pivot element to which the seat is linked to enable orientation of the seat in the reclined position and in the upright position.

Preferably, the mounting includes a frame to which the seat is pivotably linked and which is slidable to cause at least part transferal of the seat between the rear storage space and the passenger cabin space.

Preferably, the frame includes locking elements for locking the frame in position when the seat is arranged in the upright position in abutment with or close to abutting the parcel shelf.

The invention also provides a method for positioning a child seat in a car for carrying a child, the car having a passenger cabin space and a rear storage space and having a rear passenger seat that, in an upright position, divides the passenger cabin space from the rear storage space and which is foldable to provide access to the rear storage space from the passenger cabin space, the method comprising the steps of:
(a) folding the rear passenger seat to provide access to the rear storage space;
(b) transferring the child seat from a storage position in the rear storage space to the passenger cabin space via the access provided by the folded rear passenger seat; and
(c) arranging the child seat in a child carrying position in the passenger cabin space.

Preferably, in step (b), the child seat is arranged in a reclined position and step (c) involves orienting the child seat from the reclined position to an upright position for carrying a child.

Preferably, the child seat comprises a seat and a mounting linking the seat to the car and steps (b) and (c) involve operating the mounting to transfer the seat from the rear storage space to the passenger cabin space.

### BRIEF DESCRIPTION OF THE DRAWINGS

An embodiment of the invention will now be described, by way of example only, with reference to the accompanying drawings, in which:

FIG. 1 is a perspective view of a child seat in accordance with an embodiment of the invention arranged in an upright position in a passenger cabin for carrying a child;

FIG. 2 is a perspective view of the seat in FIG. 1 in a substantially reclined position for sliding rearwardly into a rear storage space for support in proximity to a parcel shelf by a support member;

FIG. 3 is a perspective view of the child seat in FIGS. 1 and 2 stowed in the rear storage space and with the rear passenger seat folded down for accessing the child seat; and

FIGS. 4A to 4I are schematic side views of the child seat, parcel shelf and rear passenger seat in a sequence for transferring the child seat from the rear storage space to the passenger cabin space for carrying a child.

### DETAILED DESCRIPTION OF AN EMBODIMENT

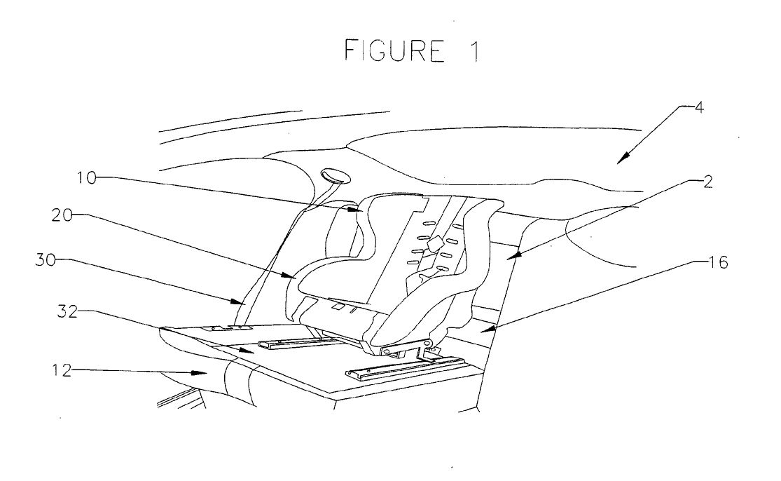

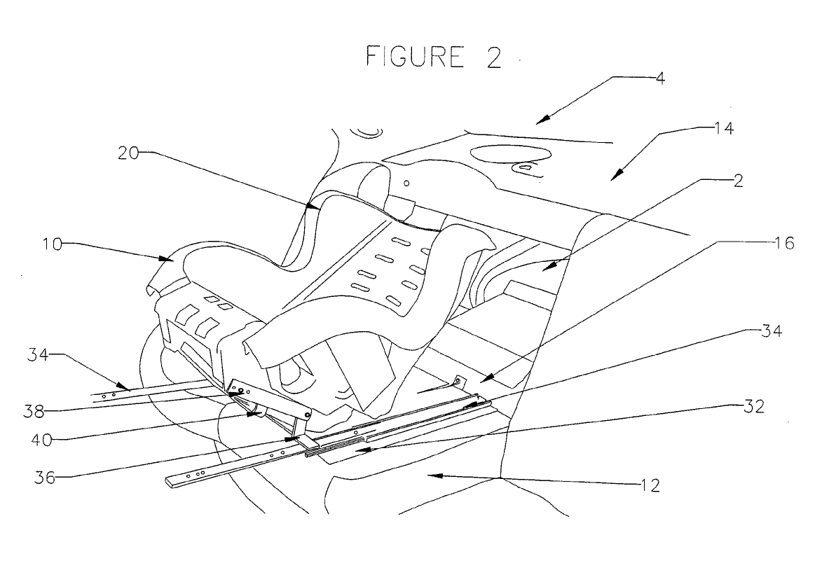

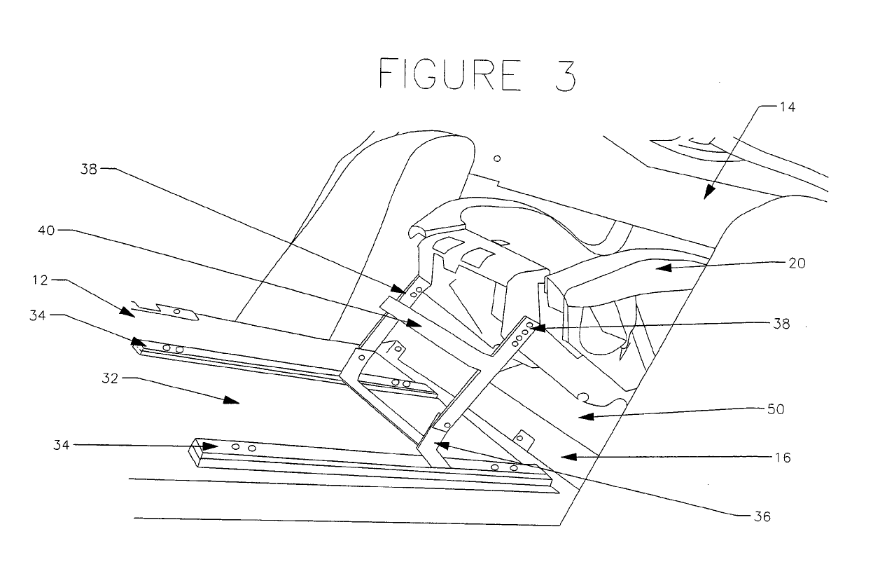

A child seat 10 for a car is shown in FIGS. 1 to 3. The child seat 10 comprises a seat 20 pivotably linked to a mounting in the form of a chassis 30.

The seat 20 comprises a plastics moulded seat that includes suitable coverings for comfort and a harness for restraining a child in the seat 20. The harness may be any form that is suitable for restraining a child.

The chassis 30 is affixed to a rearward side of a rear passenger seat 12, having regard to the normal orientation of the passenger seat for carrying passengers.

The passenger seat 12 is foldable between an upright position for carrying adult passengers and a forward position shown in FIGS. 1 and 2. In the upright position the passenger seat 12 divides a rear storage space in the form of boot 2 from a passenger cabin space in the form of cabin 4.

The chassis 30 includes a platform 32 fixed to a rearward side of the rear passenger seat 12. The platform 32 enables additional components of the chassis 30 to the rear passenger seat 12. However, the child seat 10 may comprise the additional components being directly mounted to framework in the rear passenger seat such that the platform 32 is not required. Either configuration may be used without affecting operation of the child seat 10.

A pair of telescopically slidable runners 34 are fixed in parallel alignment on the platform 32 in a direction generally perpendicular to a parcel shelf 14 of the car. Upright lugs 36 are joined to the runners 34 and an arm 38 is pivotably linked to each lug to move in a plane generally parallel to the orientation of the runners 34. The arms 38 are connected by a brace 40 such that the arms 38 move in unison. Additionally, the brace 40 can be used as a handle to facilitate transferal of the child seat 10 between the boot 2 and cabin 4 and back.

The child seat 10 further includes a lift plate 50 mounted to the floor 16 of the boot 2 immediately rearwardly of the foldable rear passenger seat 12.

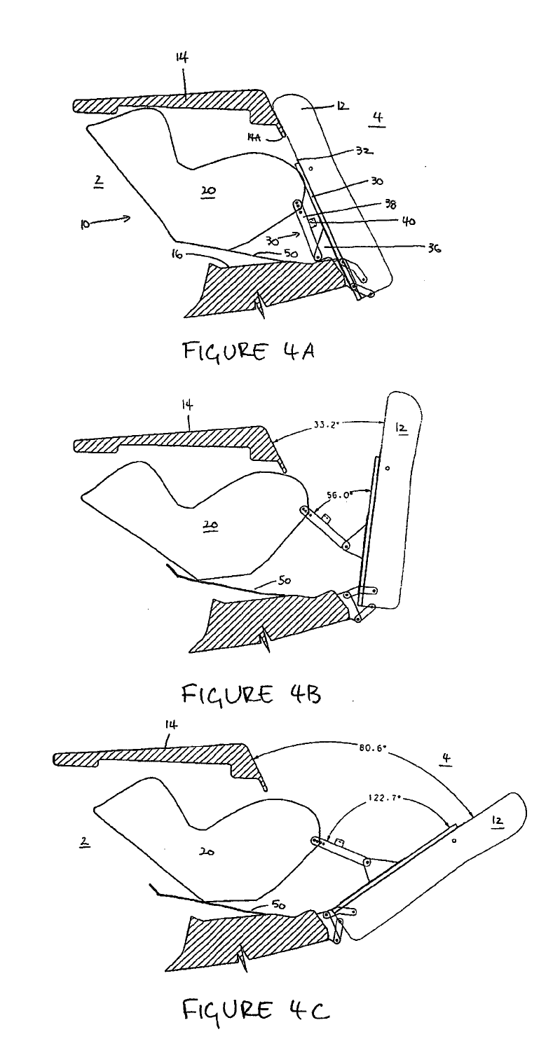

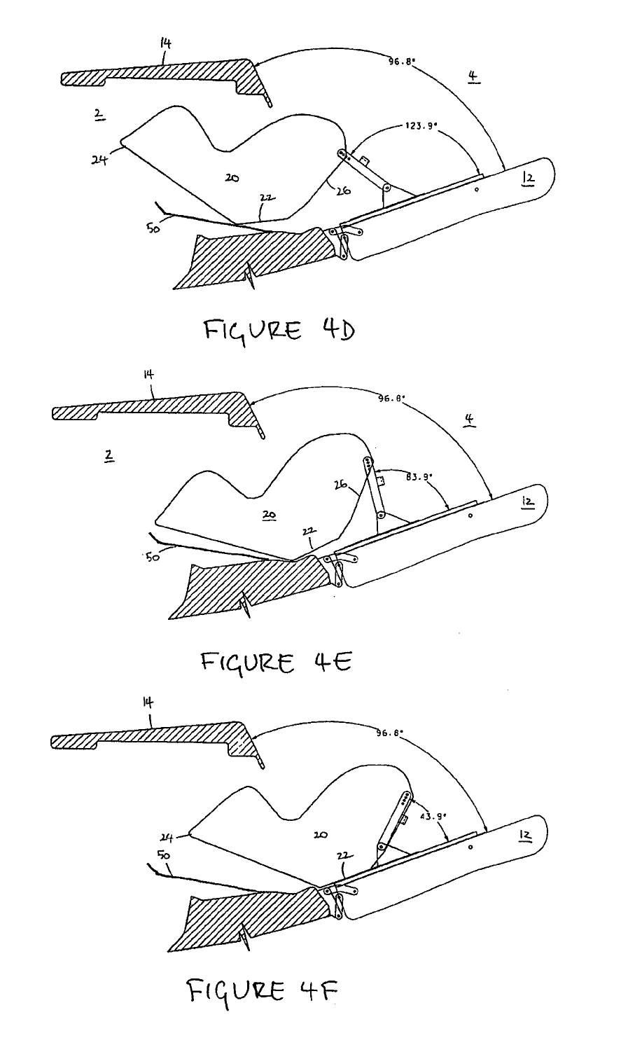

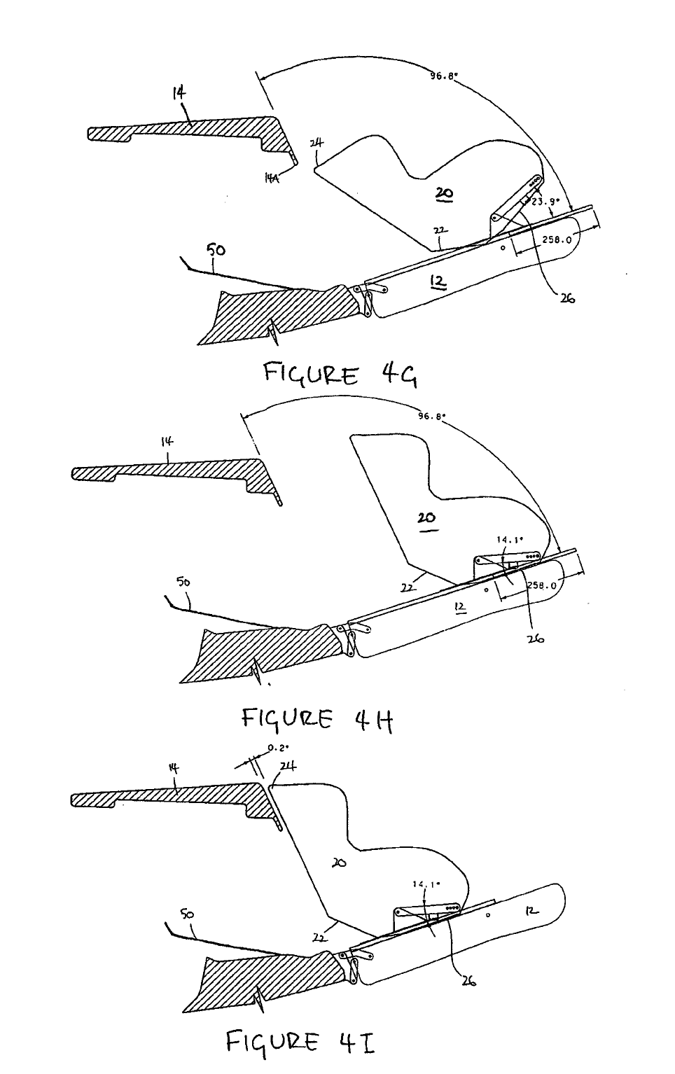

Starting with the child seat stowed in the boot 2 (FIG. 4A), the operation for transferring the child seat 10 from the boot 2 to the cabin space for carrying a child is as follows.

The rear passenger seat 12 is folded forwardly (FIGS. 4B to 4D) which drags the seat 20 from a position in close proximity to an underside of the parcel shelf 14 along the surface of the lift plate 50 and partially underneath a lower lip 14A of the parcel shelf. In the course of this movement, the seat 20 is orientated into a substantially reclined position for clearing a gap between the lower lip 14A and the flow 16.

The arms 38 are then pivoted forwardly about the lugs 36 such that a skid surface 22 on the rear of the seat 20 transitions from the lift plate 50 to the floor 16 and then onto the platform 32 (FIGS. 4D to 4F). The seat 20 remains in the reclined position during the transition.

The seat 20, still in the reclined position, is then shifted forwardly by extending the telescopic runners 34 until an integrated headrest 24 of the seat 20 clears the lower lip 14a (FIG. 4G).

The seat is then tilted forwardly from the reclined position to an upright position for carrying a child with a base 26 of the seat 20 in contact with the platform 32 (FIG. 4H). Sliding the seat 20 rearwardly on the runners 34 brings the headrest 24 into close proximity or into abutment with the parcel shelf 14 (FIG. 4I) with the effect that there is overlap between the headrest 24 and the parcel shelf 14. This is important for rear-collisions to provide support for the headrest 24 and thereby prevent whiplash injuries in the event seat 20 deforms under the momentum of a sudden impact.

The runners 24 include lockable catches (not shown) to lock the runners 34 in position as shown in FIG. 4I with the seat 20 arranged in an upright position.

The catches are releasable as required to transfer the child seat 10 to the boot 2 for storage. Transferring the child seat to the boot 2 is achieved by reversing the sequence described above for transferring the child seat 10 from the boot 2 to the cabin 4.

In an alternative form, the child seat 10 is mounted to an underside of the parcel shelf for transfer between the boot 2 and cabin 4.

The lift plate 50 cooperates with the skid surface 22 of the seat 20 to push the seat 20 upwardly to a position below and in close proximity to the underside of the parcel shelf 14. Raising the seat 20 to such a position saves the remainder of the space in the boot that is most commonly used for storing items, i.e. generally at floor level, free for storage of such items.

This is an important aspect of the child seat 10 because, although some storage space in the boot 2 is sacrificed, the storage space that is utilised is the least commonly used storage space immediately behind the rear passenger seat and immediately below the parcel shelf 14. Accordingly, the amount of storage space in the boot 2 that is sacrificed is reduced.

Furthermore, the child seat 10 can be transferred between the boot 2 and the cabin 4 and back with relative ease. Accordingly, there is a reduced perception of the difficulty of installing or storing the child seat 10 in the event that there is a need to reconfigure the rear passenger seat for carrying a child or for carrying an adult respectively. The increase in ease of use and reduced perception of difficulties provides are car that has greater flexibility in use for carrying children and adults in the rear passenger seat safely.

Many modifications may be made to the preferred embodiment of the present invention as described above without departing from the spirit and scope of the present invention.

It will be understood that the term “comprises” or its grammatical variants as used in this specification and claims is equivalent to the term “includes” and is not to be taken as excluding the presence of other features or elements.

1. A child seat for a car with a rear passenger seat that divides a passenger cabin space and a rear storage space and that is foldable to provide access to the rear storage space from the passenger cabin space, the child seat comprising (a) a child seat which retains the same shape when carrying a child and when stowed and (b) a mounting that links the child seat to the rear of the rear passenger seat, the mounting is operable to transfer the child seat between the rear storage space and the passenger cabin space such that the child seat is stowed in the rear storage space when the rear passenger seat is upright and that the child seat is locatable in the passenger cabin space for carrying a child when the rear passenger seat is folded.

2. The child seat defined in claim 1, wherein the child seat is a permanent fixture in the car or is retro-fittable to become a permanent fixture in the car.

3. The child seat defined in claim 1, wherein the car includes a parcel shelf which, in conjunction with the rear passenger seat, divides the passenger cabin space and the rear storage space and the mounting is configured to locate the seat such that at least part of the seat is in abutment with or close to abutting the parcel shelf when the seat is located in the passenger cabin space for carrying a child.

4. The child seat defined in claim 3, wherein the mounting is configured to stow the seat in close proximity to the parcel shelf.

5. The child seat defined in claim 1, wherein the mounting is configured to retain the seat above the floor of the rear storage space.

6. The child seat defined in claim 3, wherein the mounting is affixed to framework of the car associated with the parcel shelf.

7. The child seat defined in claim 1, wherein the mounting is affixed to the rear of the foldable rear passenger seat such that the seat is stored in the rear storage space when the rear passenger seat is located in an upright position to divide the rear storage space from the passenger cabin space.

8. The child seat defined in claim 7, wherein the mounting includes a support that directs the seat upwardly to a position in close proximity to the parcel shelf.

9. The child seat defined in claim 7, wherein the seat is pivotably linked to the mounting for orienting the seat between a reclined position for transferring the seat between the passenger cabin space and the rear storage space and an upright position for seating a child.

10. The child seat defined in claim 9, wherein the mounting includes at least one pivot element to enable orientation of the seat in the reclined position and in the upright position.

11. The child seat defined in claim 7, wherein the mounting includes a frame to which the seat is pivotably linked and which is slidable to cause at least part transferal of the seat between the rear storage space and the passenger cabin space.

12. The child seat defined in claim 11, wherein the frame includes locking elements for locking the frame in position when the seat is arranged in the upright position in abutment with or close to abutting the parcel shelf.

13. A method for positioning a child seat in a car for carrying a child, the car having a passenger cabin space and a rear storage space and having a rear passenger seat that, in an upright position, divides the passenger cabin space from the rear storage space and which is foldable to provide access to the rear storage space from the passenger cabin space, the method comprising the steps of:
(a) folding the rear passenger seat to provide access to the rear storage space;
(b) transferring the child seat from a storage position in the rear storage space to the passenger cabin space via the access provided by the folded rear passenger seat; and
(c) arranging the child seat in a child carrying position in the passenger cabin space.

14. The method defined in claim 13, wherein, in step (b), the child seat is arranged in a reclined position and step (c) involves orienting the child seat from the reclined position to an upright position for carrying a child.

15. The method defined in claim 13, wherein the child seat comprises a seat and a mounting linking the seat to the car and steps (b) and (c) involve operating the mounting to transfer the seat from the rear storage space to the passenger cabin space.

16. A child seat for a car with a rear passenger seat that divides a passenger cabin space and a rear storage space and that is foldable to provide access to the rear storage space from the passenger cabin space, the child seat comprising (a) a child seat which retains the same shape when carrying a child and when stowed and (b) a mounting that links the child seat to the rear of the rear passenger seat, the mounting is operable to transfer the child seat between the rear storage space and the passenger cabin space such that the child seat is stowed in the rear storage space when the rear passenger seat is upright and that the child seat is locatable in the passenger cabin space for carrying a child when the rear passenger seat is folded and wherein the seat is pivotably linked to the mounting for orienting the seat between a reclined position for transferring the seat between the passenger cabin space and the rear storage space and an upright position for seating a child.
